(19) United States
(12) Patent Application Publication
(10) Pub. No.: US 2004/0040015 A1
(43) Pub. Date: Feb. 26, 2004

(54) Systems and methods for implementing extensible generic applications

(75) Inventor: William A. Jordan II, Westminster, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NETdelivery Corporation, Boulder, CO

(21) Appl. No.: 10/226,750

(22) Filed: Aug. 23, 2002

(51) Int. Cl. G06F 9/45; G06F 7/00

(52) U.S. Cl. 717/136; 707/104.1

(57) ABSTRACT

Systems and methods for implementing applications that are extensible to a variety of specific formats. The specific formats include, but are not limited to, language, data units and user specific graphics. Some of the methods include creating a generic application and an associated translation master, and applying the translation master to the generic application to create a specific application. Some of the systems include computer readable medium comprising instructions for implementing the methods.

### CROSS REFERENCE TO RELATED APPLICATIONS

The present invention is related to U.S. patent application Ser. No. ______, entitled SYSTEMS AND METHODS FOR STORING DIFFERING DATA FORMATS IN FIXED FIELD DEFINITIONS (Attorney Docket Number 019555-005100US); and U.S. patent application Ser. No. ______, entitled SYSTEMS AND METHODS FOR IMPLEMENTING DATABASE INDEPENDENT APPLICATIONS (Attorney Docket No. 019555-005200US) all of which are incorporated herein by reference for all purposes and filed on a date even herewith.

### BACKGROUND OF THE INVENTION

The present invention relates generally to development of computer applications. More particularly, the invention relates to systems and methods for developing generic computer applications that are extensible for use as specific computer applications. Such specific applications can be tailored to a number of situations including, but not limited to, specific languages, data formats and/or data units.

In a typical scenario, a software application is developed for a particular user and/or situation. For example, a software application may be developed for use by a first company. Such software is tailored to the needs and data requirements of the first company, including placement of the company logo on various displays associated with the software. A second company may desire similar software, although tailored to the specific needs of the second company. Thus, two similar software products are developed and maintained to service the two companies.

This is somewhat acceptable where both companies perform their own software development and software maintenance. However, it has become increasingly popular to outsource software maintenance and development. In some cases, such outsourcing has resulted in one software services supplier supplying support and software to two companies requiring common functions. This is inefficient as it involves unnecessary effort. Thus, there is a need for systems and methods to avoid various inefficiencies in the present software and services market.

### BRIEF SUMMARY OF THE INVENTION

The present invention provides systems and methods for developing and maintaining an application that is extensible for use in a variety of different specific circumstances. For example, a generic accounting program may be developed that can be deployed with, among other things, a specific brand, language, units, and data requirements. In some embodiments, the applications are software applications executable by a computer.

One method according to the present invention includes creating a generic application, such as, for example, a set of JAVA Server Pages applicable to a variety of users. In addition, a translation master associated with the generic application is created. The translation master is applied to the generic application such that the generic application is converted to a specific application. In particular embodiments, the generic application is designed for use in relation to a group of countries, and the specific application is designed for use in relation to a subset of the group of countries.

In some embodiments, the translation master includes a default designation for a data entry field associated with the generic application. When the translation master is applied to the generic application, the default designation is displayed in association with the data entry field.

In other embodiments, an alternative designation to the default designation is provided in the translation master. In such embodiments, applying the translation master to the generic application involves displaying the alternative designation in association with the data entry field of the generic application. In particular embodiments, the default designation is in a first language and the alternative designation is in a second language.

In yet other embodiments, the translation master comprises an inclusion field associated with a generic field of the generic application. The inclusion field can be used to select which of the various generic fields are displayed.

Embodiments of systems in accordance with the present invention include a computer readable medium that stores a generic application, a translation master, and computer instructions. The computer instructions are executable to apply the translation master to the generic application.

Other embodiments of systems in accordance with the present invention include a computer readable medium comprising elements for executing a generic application in a manner specific to a designated country. The computer medium comprises a generic application including a first field and a second field; a translation master including a first default designation associated with the first field, a second default designation provided in a first language and associated with the second field, and an alternative designation provided in a second language and associated with the second field; and computer instructions executable by a computer to apply the translation master to the generic application. Application of the translation master to the generic application creates a specific application comprising a display of the first default associated with the first field and the alternative designation associated with the second field.

The summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates the logical relationship of applications and databases involved in implementing database independent applications in accordance with an embodiment of the present invention;

FIGS. 2a and 2b illustrate flow diagrams outlining methods of creating applications and databases in accordance with various embodiments of the present invention;

FIG. 3 illustrates a generic application in accordance with one embodiment of the present invention;

FIGS. 4a and 4b illustrate a translation master with default designations and inclusion fields applied to the generic application of FIG. 3; and

FIGS. 5a and 5b illustrate a translation master with alternative designations and inclusion fields applied to the generic application of FIG. 3.

### DETAILED DESCRIPTION OF THE INVENTION

The present invention provides systems and methods for allowing an independent implementation of a database that can grow and change as data needs change. Such growth can be accomplished without requiring regeneration of applications used in relation to a particular database. More particularly, the invention provides systems and methods for conversion between various database types, for creating a data access layer to insulate a group of applications from any particular database, and for providing a location or user specific implementation of a database. These and other inventions are disclosed in the following detailed description.

Various embodiments of the present invention provide an extensible generic way to allow differing international mailing address formats to be defined and stored is described. This illustrative embodiment uses standard storage fields and allows the definition of the address fields to be defined outside a core system in an implementation independent manner. For the purposes of this description, the core system is some database or data defining layer. The embodiments provide a method of packing and unpacking the storage fields to and from a common storage area. The packing and unpacking methods can be implemented in software maintained apart from the core system. This separation of the packing and unpacking code from the core system allows each country to have separate modules to handle their specific idiosyncrasies and to perform country specific validation and verification. Further, maintaining this code apart from the core system allows for country specific data collection without a need to redevelop or modify the core system for each new format encountered. This makes applications more stable, reusable and efficient to develop and maintain. While such embodiments illustrate various aspects of the present invention, it should be recognized that many other examples of storing differing data formats in a common format are possible in accordance with the present invention.

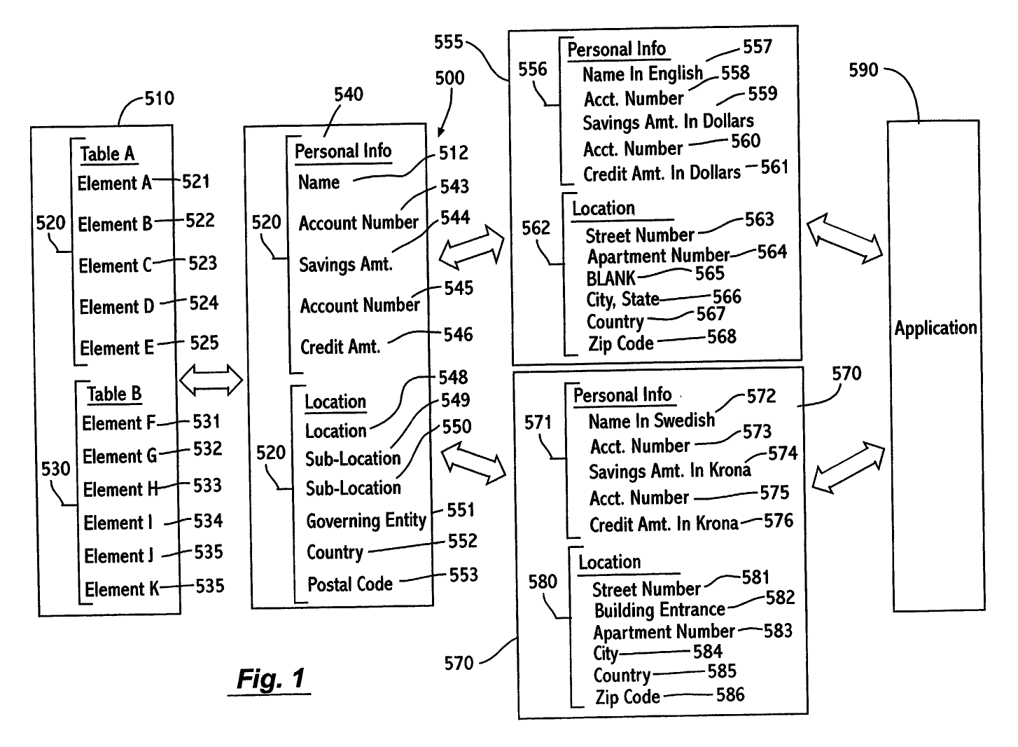

Referring to FIG. 1, a logical grouping 500 of structures involved in implementing database independent applications in accordance with an embodiment of the present invention is illustrated. Logical grouping 500 comprises a common storage area 510 defined as tables 520, 530 of standard data elements 521, 522, 523, 524, 525 and 531, 532, 534, 535, 536, respectively. In some embodiments, common storage area 510 is a database. In addition, logical grouping 500 comprises a generic data set 540 with a personal information table 542 that is mappable to table 520 and a location information table 547 that is mappable to table 530. Personal information table 542 includes elements 543, 544, 545, 546. Location information table 547 includes elements 548, 549, 550, 551, 552, 553.

Logical grouping 500 includes two specific data sets 555, 570 with tables that are mappable to generic data set 540. More specifically, personal information tables 556, 571 are mappable to personal information table 542 and location information tables 562, 580 are mappable to location information table 544. Personal information table 556 includes elements 557, 558, 559, 560, 561 and personal information table 571 includes elements 572, 573, 574, 575, 576. Location information table 562 includes elements 563, 564, 565, 566, 567, 568 and location information table 580 includes elements 581, 582, 583, 584, 585, 586.

Thus, name in English 557 and name in Swedish 572 are mappable to name 542 and in turn mappable to element A 521. Account numbers 558, 573 are mappable to account number 543 and in turn to element B 522. Savings amounts 559, 574 are mappable to savings amount 544 and in turn to element C 523. Account numbers 560, 575 are mappable to account number 545 and in turn to element D 524. Credit amounts 561, 576 are mappable to credit amount 546 and in turn to element E 525. Street numbers 563, 581 are mappable to location 548 and in turn to element F 531. Street numbers 563, 581 are mappable to location 548 and in turn to element F 531. Apartment numbers 564, 583 are mappable to sub-location 549 and in turn to element G 532. Building entrance 582 is mappable to sub-location 550 and in turn to element H 533. City, state 566 and city 584 are mappable to governing entity 551 and in turn to element I 534. Country 567 and 565 are mappable to Country 552 and in turn to element J 535. Zip code 568 is mappable to postal code 553 and in turn to element K 536.

An application 590 is capable of receiving and/or outputting information formatted in accordance with either specific data set 555 or specific data set 570. In some embodiments, application 590 provides different input and output functionality based upon which of the specific data sets 555, 570 are chosen to provide data to or receive data from application 590. For example, displays associated with application 590 can be in English where specific data set 555 is chosen or Swedish where specific data set 570 is chosen. In this way, application 590 can be a generic application that is extensible into various country specific applications through selection of a data set relevant to the specific country.

In such embodiments, application 590 can operate an environment specific to a particular country as defined by the specific data set without requiring redevelopment tailored to the specific country. Thus, for example, application 590 can be provided to Swedish users by selecting specific data set 570. This allows application 590 to gather and provide information germane to a Swedish user as defined by specific data set 570. More particularly, location information (table 564) includes a street number 581, a building entrance 582, an apartment number 583, a city 584, and a country 585 consistent with physical address formats in Sweden. Where Sweden does not use a zip code, a blank 586 is provided. This is in contrast to specific data set 555 where the location information (table 554) includes a street number 563, an apartment number 564, no building entrance represented as a blank 565, a city and state combined 566, a country 567, and a zip code 568.

Furthermore, information in units specific to Sweden can be provided to and from application 590 by selection of specific data set 570. More particularly, personal information (table 571) includes a person's savings (574) and credit (576) amounts in Krona. This is in contrast to specific data set 555 where the personal information (table 556) provides the savings (559) and credit (561) amounts in Dollars.

While specific data sets 555, 570 provide access to information in a format germane to a particular country or group of countries, generic data set 540 provides for maintaining information associated with specific data sets 555, 570 in a default or generic format. Thus, the combination of specific data sets 555, 570 and generic data set 540 provide for data to be represented in a specific format, while being maintained on a database in a generic format. As a illustrative example, a persons credit amount can be maintained generically in Brazilian Reales as indicated by generic data set 540, credit amount 545 and physically stored as an element E 525 of common storage area 510. When presented to a user of application 590, credit amount 545 is either presented as credit amount 561 in Dollars or credit amount 576 in Krona depending upon which specific data set 555, 570 is selected.

As another illustrative example, a person's mailing address can be maintained in a generic format (547) within generic data set 540 and physically stored as a table 530 within common storage area 510. When presented to a user of application 590, the mailing address is displayed in a format germane to the user's country as provided by selection of specific data set 555 or 570.

Thus, as illustrated in FIG. 1, the present invention provides for development of a single application capable of deployment in a variety of user specific formats. Furthermore, the present invention provides for maintenance of a generic data set that is accessible in a variety of user specific formats. According to embodiments of the present invention, a generic application and a generic storage area can be developed. The generic application and storage area can be deployed in a user specific environment by providing specific data sets and without requiring development of either the application or the database specific to the user environment. It should be recognized that the preceding discussion illustrates an embodiment of the present invention and that other embodiments may allow for access of different data types using a similar approach.

For example, other embodiments can maintain and access engineering data related to a product design and allow different groups working on the product development to access the engineering data in a manner particularly tailored to their needs. Yet other embodiments of the present invention utilize an application tailored for each specific data set. For example, such embodiments can include an application tailored for specific data set 555 and another application tailored for specific data set 570. This involves maintenance and development of multiple applications, but also allows for some additional flexibility in developing and modifying such applications.

In some embodiments, the schema and commands associated with specific data sets 555 and/or 570 are incorporated into a data access layer as previously discussed. The schema outlines the data elements provided in specific data sets 555, 570 and the commands can comprise computer instructions for converting between specific data sets 555, 570 and generic data set 540. Further, the commands can include computer instructions for creating, reading, updating, deleting, encrypting and/or decrypting elements stored on common storage space in accordance with generic data set 540 and consistent with methods previously discussed.

As an example, accessing credit amount data 576 from common storage area 510 via a data access layer incorporating specific data set 570 can include a number of processes implemented in the form of computer instructions within the data access layer. More particularly, the processes can include retrieving element E 525 from common storage of a type defined by generic data set 540, credit amount 546. Converting credit amount 546 from, for example, Brazilian Reales to Swedish Krona and validating that the converted number is consistent with the type defined as credit amount 576. Then providing the retrieved information to application 590. Other examples involve decrypting information where the information is maintained in encrypted format on common storage area 510. Such decryption is typically provided when the information is retrieved from common storage 510 prior to converting from generic data set 540 to specific data set 570. Such a conversion from generic data set 540 to specific data set 570 is generally referred to as unpacking.

Another example involves providing information via application 590 to common storage area 510. Such an example can involve receiving an updated version of a person's location information via application 590 and processing the information via specific data set 570 to store it in a table B 530 of common storage area 510. The persons street number, building entrance, apartment number, city and country are provided to application 590. Application 590 transfers the received information to a data access layer incorporating specific data set 570 where the received information is validated and verified.

Such validation and verification can include any number of processes to assure that acceptable information was provided via application 590. For example, validation and verification can include checking to assure that the information can fit within the storage area defined as location information table 580. Alternatively, or in addition, validation and verification can involve determining if the provided information represents a valid physical address. More particularly, in a situation where the information provided via application 590 does not include the person's city, computer instructions implemented in the data access layer can identify the deficiency in the information, generate an error message, and communicate the error to application 590. Application 590 can then re-request the information and provide the corrected information via the data access layer including specific data set 570. By providing validation and verification separate from both the core database and the application, a different validation and verification can be implemented for each specific deployment of a generic application and database without requiring modifications to either the database or the application.

The verified and validated information can then be converted from specific data set 570 to generic data set 540. Such conversion from specific data set 570 to generic data set 540 is generally referred to as packing. The packing can include conversion of data types, such as, for example, conversion of a 128-bit field to a 96-bit field. In addition, packing can include conversion of units, such as from Krona to Reales. Further, the packing can include associating information from specific data set 570 with the proper element in generic data set 540. For example, packing includes associating apartment number 583 with sub-location 549 and building entrance 582 with sub-location 550. It should be recognized that within the scope of the present invention, other commands can be associated with either or both of packing and unpacking processes.

After the packing is complete, information maintained in the format defined in generic data set 540 is written to common storage area 510. More particularly, location information table 547 is written as table B 530. In some embodiments, writing information to common storage area 510 includes encrypting one or more data elements that are to be maintained in an encrypted format on common storage area 510.

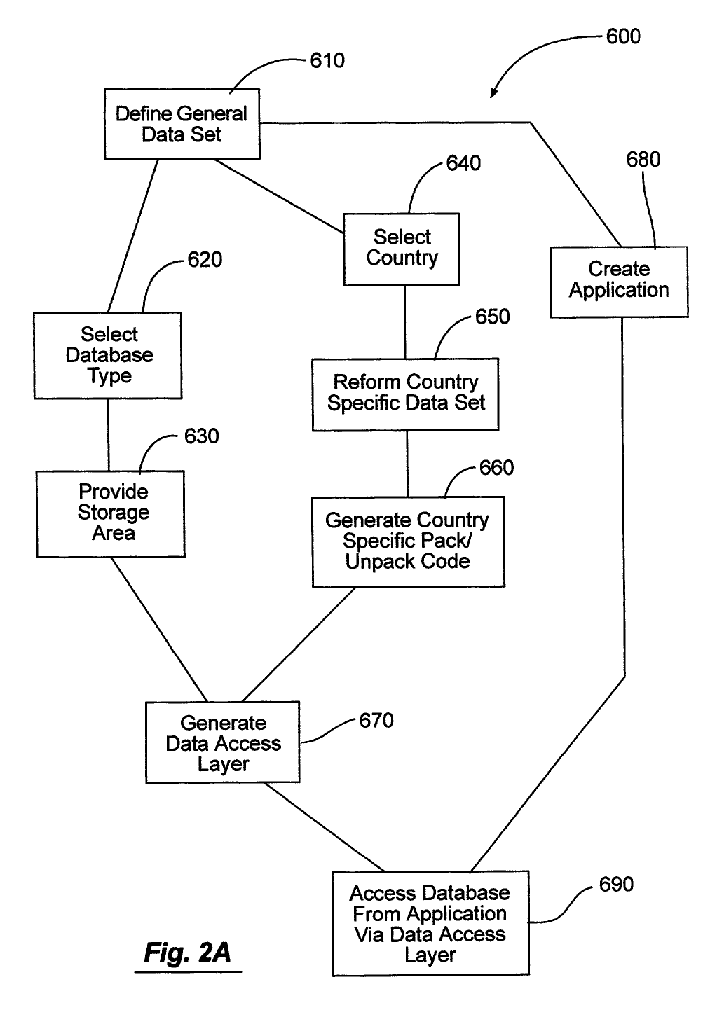

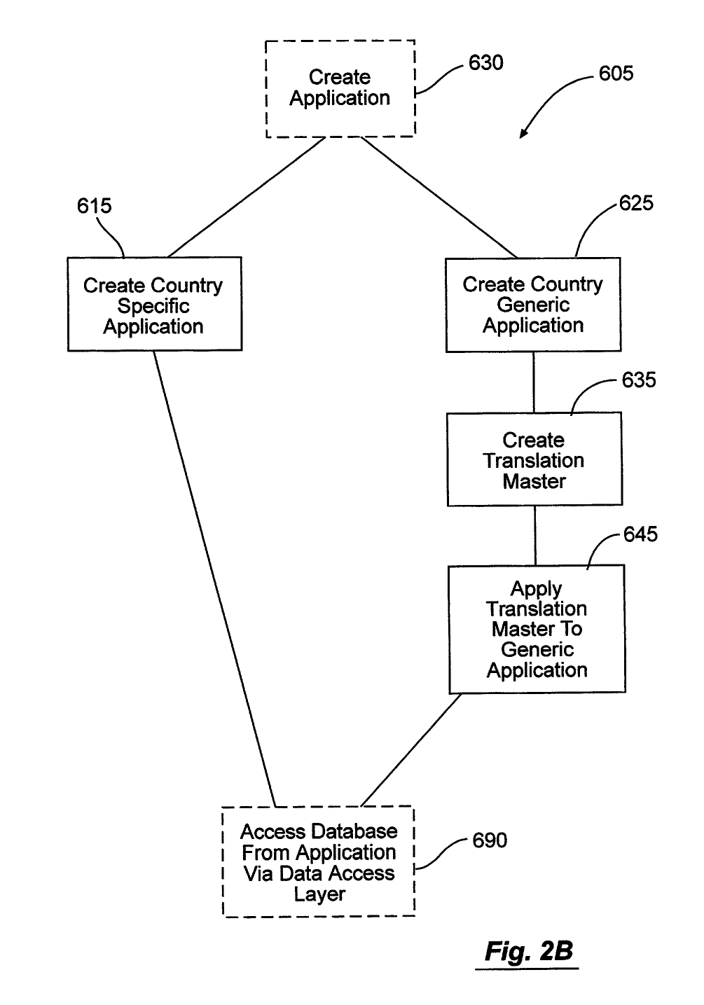

Referring to FIG. 2a, flow diagram 600 illustrates an embodiment in accordance with the present invention incorporating methods for implementing databases and applications. Flow diagram 600 begins by defining a generic data set (block 610). Definition of a generic data set (block 610) includes defining a data set that is sufficiently robust to handle data variations associated with providing data to a variety of applications. This is true even where the variety of applications are actually a single generic application deployed in a variety of ways, such as application 590 discussed in relation to FIG. 1. As an illustration, defining the generic data set results in generic data set 540 where a generic location table 547 is defined such that it can include sufficient information to allow access in a Swedish or United States address format.

Based on the defined generic data set (block 610), physical storage space can be selected and allocated (blocks 620, 630). Selection of the physical storage space (block 620) can include selecting the particular type of database that will be used to store the data. As previously discussed, a variety of database types are useful in relation to the present invention, including, but not limited to, Oracle and SQL databases. With the database selected (block 620), the physical storage space on the selected data base is defined and allocated (block 630). The physical storage space is allocated to maintain the previously defined generic data set.

In addition, the various specific data sets are defined and generated (blocks 640, 650, 660). Specific data sets are generated by selecting the specific nature of the data set (block 640). For example, where a common application and/or database are developed for use across a variety of countries, the specific nature of the data set can be selected to be a particular country (block 640). For illustration, Sweden is selected (block 640). With Sweden selected (block 640), a data set specific to Sweden is defined (block 650), such as, for example, specific data set 570. This data set is defined to include nuances specific to the chosen country, including, but not limited to, building entrance 582, and credit 576 and savings 574 amounts in Krona. Packing and unpacking commands for converting between the generic data set and the specific data set are then generated (block 660). As previously discussed, such packing and unpacking commands can include computer instructions for conversion of data types, conversion of units, associating elements of the specific data set with elements of the generic data set, and/or other such commands.

With the storage area selected and allocated (blocks 620, 630) and the specific data sets defined and generated (blocks 640, 650, 660), a data access layer (similar to data access layer 290 discussed in relation to FIG. 2 of U.S. patent application Ser. No. ______, entitled SYSTEMS AND METHODS FOR IMPLEMENTING DATABASE INDEPENDENT APPLICATIONS (Attorney Docket No. 019555-005200US)) is generated (block 670). Beyond the elements discussed in relation to the data access layer, the generated data access layer can include commands for packing and unpacking between the generic data set and the specific data set(s).

In addition, an application that accesses the common storage area designated by the generic data set is created (block 680). Creation of the application is described below in more detail in relation to FIG. 2b. After creating the application (block 680), the created application can access the common data area via the data access layer that incorporates specific data set (block 690). As a specific example, an include file (not shown) associated with application 590 can be modified to indicate that operation in Sweden is selected. Based on this indication, the application can query a user for location information in a format that requests a Swedish address consistent with the definition provided in specific data set 570 forming part of the data access layer. The information entered by the user is then packed into generic data set 540 and stored to common data area 510.

Referring to FIG. 2b, a flow diagram 605 illustrating exemplary methods of creating an application are provided. In general, applications are created according to methods known in the art for creating software applications. However, such methods can be augmented in accordance with the present invention to take advantage of specific and generic data sets. Such creation can include developing an application tailored to the specific nature of a particular data set (block 615). For example, application 590 can be a Swedish specific application that only functions in conjunction with a data access layer incorporating specific data set 570.

Alternatively, a generic application can be developed (blocks 625, 635, 645). Such a process includes developing an application that is tailored to use the generic data set. For example, application 590 can be an application for gathering location information about various persons. Application 590 would be generically developed to request location information 547 of generic data set 540. Such information includes a person's LOCATION 548, SUB-LOCATION 549, SUB-LOCATION 550, GOVERNING ENTITY 551, COUNTRY 552, and POSTAL CODE 553.

Application 590 can be further developed to request the aforementioned information based on a specific data set 555, 570. Thus, when specific data set 570 is selected, generically developed application 590 requests specific information in place of the generic information. More particularly, the generically coded request for LOCATION 548 is converted to a specific request for street number 581 of specific data set 570. Similarly, the generically coded requests for SUB-LOCATION 549, SUB-LOCATION 550, GOVERNING ENTITY 551, COUNTRY 552, are converted to specific requests for apartment number 583, building entrance 582, city 584 and country 585, respectively. The generically coded request for POSTAL CODE 553 is not presented to the user of application 590 as it is Blank 586 in specific data set 570. In some embodiments, a particular specific data set 555, 570 is selected by definition in an include file associated with application 590.

Further in the embodiment, a translation master associated with the application is created (block 635). Such a translation master operates to modify various graphics and/or functions or processes associated with the application. Thus, for example, where the application is generically coded to display the following request “ENTER YOUR MAILING ADDRESS” in English, a Swedish translation of the request can replace the default English text. Such translation masters are discussed below in more detail with reference to FIGS. 7-9. The translation master is then applied to the generically coded application to create graphics and/or functions for the desired specific application (block 645). In some embodiments, application of the translation master is performed similarly to selection of the specific data set. More particularly, the translation master is incorporated in or referenced by an include file associated with the application. In other embodiments, the translation master and the specific data set are both incorporated into a data access layer. In such embodiments, the data access layer performs a dual role of isolating the application from the database and providing control over graphics and/or functions associated with tailoring a generic application to a specific application.

It should be recognized that variations on flow diagrams 600, 601 are possible in accordance with the present invention. For example, in some embodiments, two or more specific data sets are first defined (blocks 640, 650, 660). Then, a generic data set associated with the specific data sets is automatically generated (block 610). This approach provides a greater understanding of the needs of the generic data set based on previously defined specific data sets. With the generic data set defined, other steps as previously discussed, including definition and generation of alternative specific data sets are accomplished.

Alternatively, the method can be implemented where the data access layer is not created (block 670) and the application is not created (block 680). Further modifications are possible in accordance with the present invention.

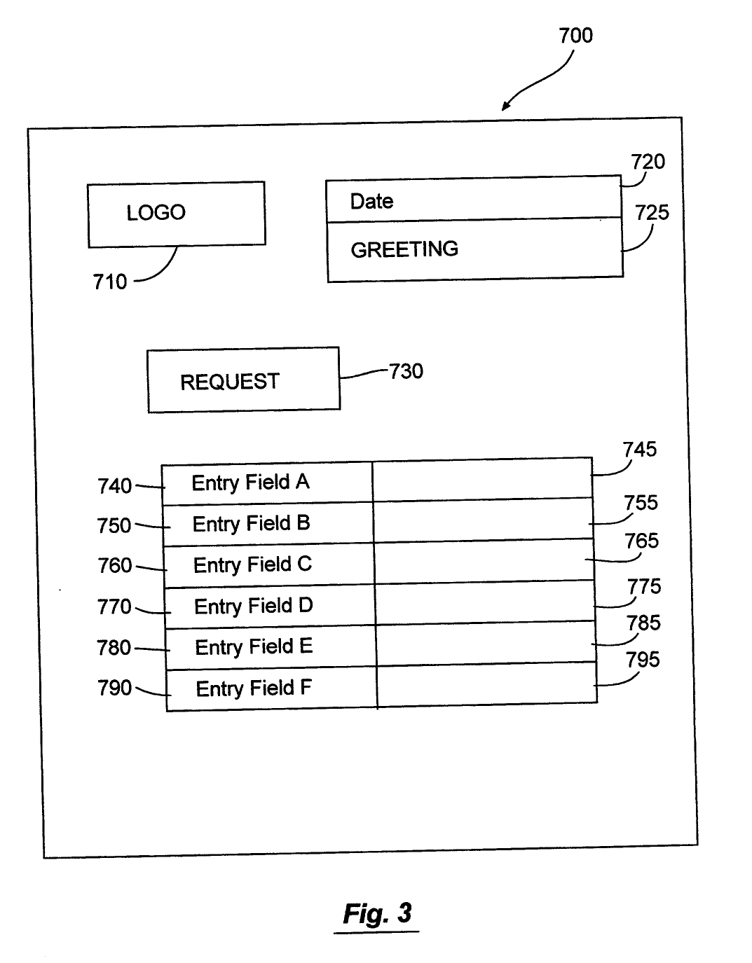

Referring to FIG. 3, a graphical interface 700 of a generic application is illustrated. Graphical interface 700 is designed to request address information from a user. Graphical interface 700 includes a logo field 710, a date field 720, a greeting field 725, a request field 730, an entry field A 740, an entry field B 750, an entry field C 760, an entry field D 770, an entry field E 780, and an entry field F 790. Each of the entry fields 740, 750, 760, 770, 780, 790 are associated with respective data entry fields 745, 755, 765, 775, 785, 795. The data entry fields provide windows for entering data associated with the respective entry fields 740, 750, 760, 770, 780, 790.

As an example, entry fields 740, 750, 760, 770, 780, 790 can be developed to receive information consistent with Location information table 547 of generic data set 540. When a specific data set is applied as previously discussed, data entry fields 745, 755, 765, 775, 785, 795 expect data as defined in the specific data set. Thus, for example, where specific data set 570 is selected, data entry field 745 expects street number 581, data entry field 755 expects building entrance 582, data entry field 765 expects apartment number 583, data entry field 775 expects city 584, data entry field 785 expects country 585, and data entry field is not displayed as Blank 586 is provided in specific data set 570.

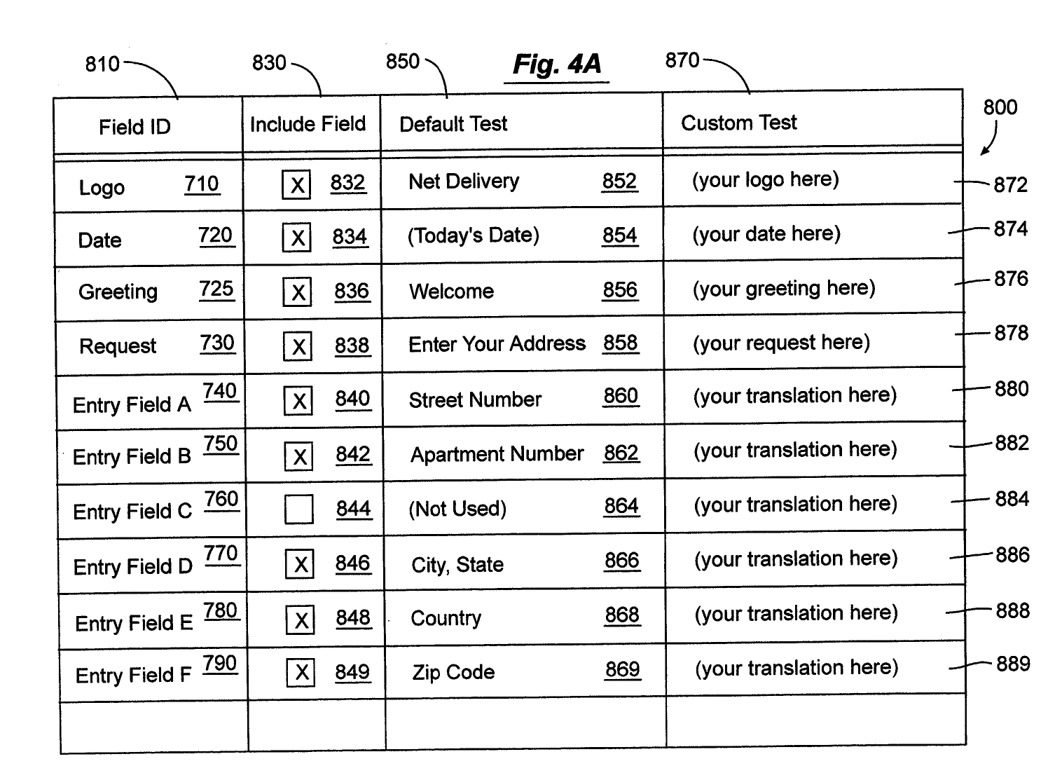

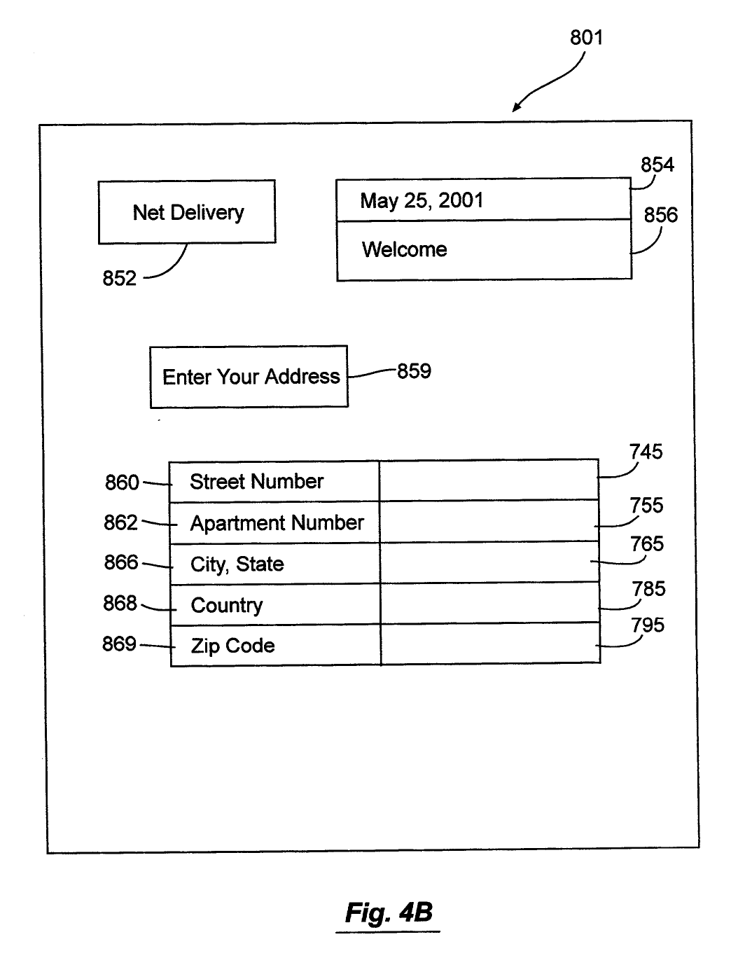

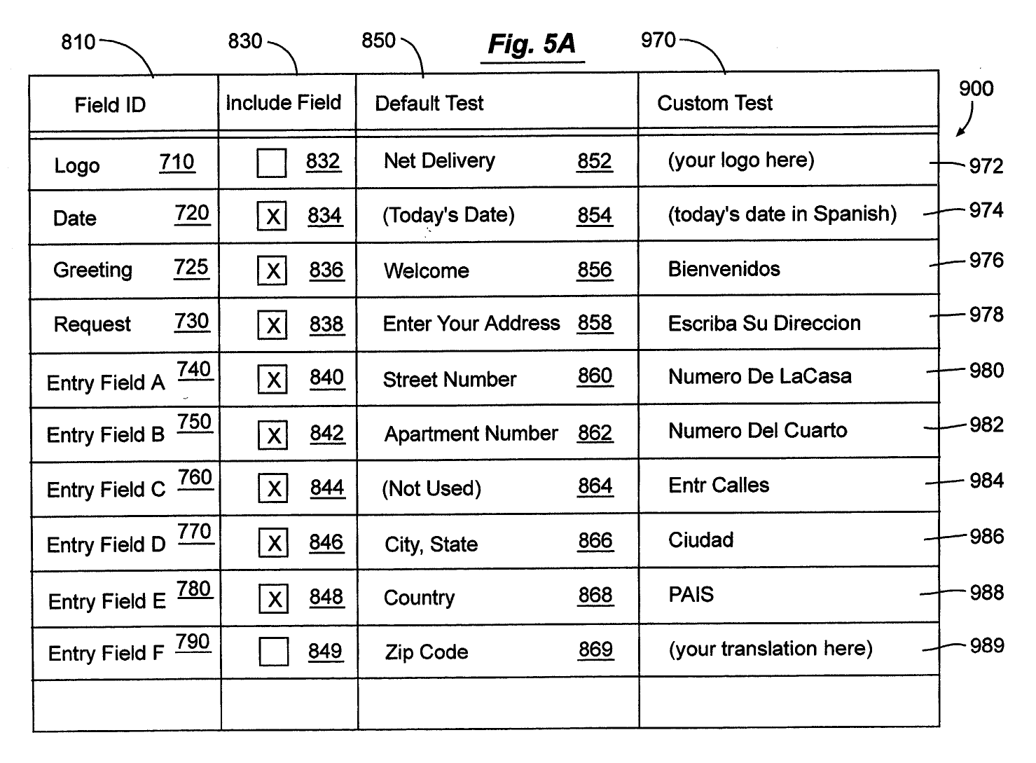

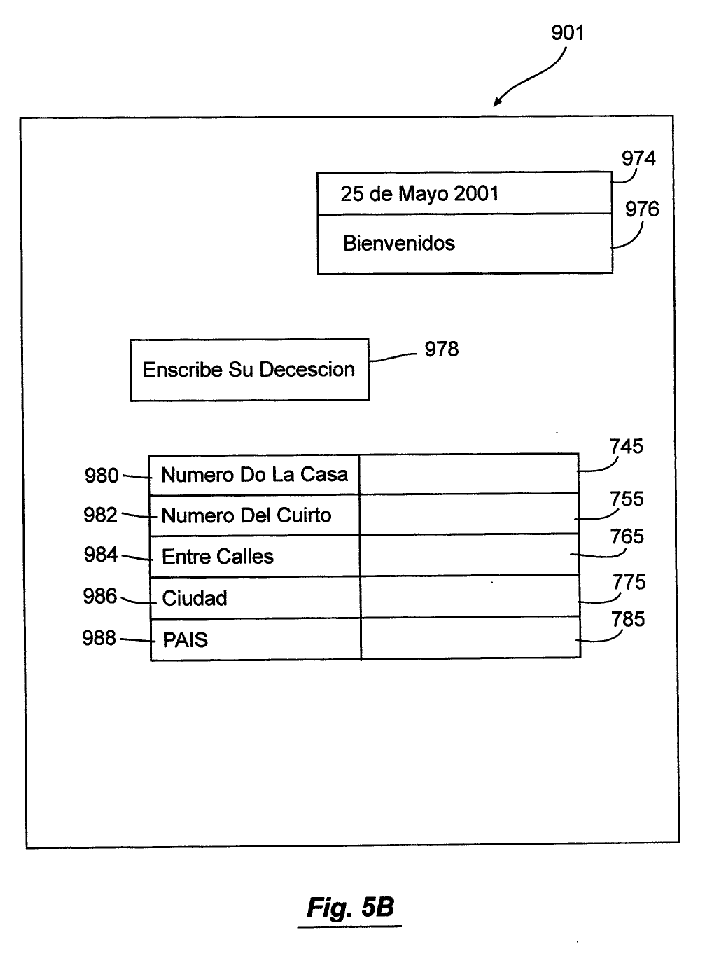

As described in FIGS. 4 and 5, the various fields of graphical interface 700 can be modified by use of a translation master. Such use of a translation master can be in addition to other systems and methods described herein, or apart from other systems and methods described herein. For example, an application can be developed and used with a translation master without using specific data sets and/or data access layers as previously described. However, other embodiments incorporate combinations of data access layers, specific and generic data sets, along with translation masters.

Referring to FIG. 4a, a translation master 800 in accordance with an embodiment of the present invention is described. Translation master 800 includes a field identification set 810, an field inclusion set 830, a default text set 850 and a custom text set 870. Field identification set 810 includes various fields provided in graphical interface 700, including logo field 710, date field 720, greeting field 725, request field 730, and entry fields 740, 750, 760, 770, 780, 790. Field inclusion set 830 includes selection boxes 832, 834, 836, 838, 840, 842, 844, 846, 848 each associated with respective elements of field identification set 710.

Default text set 850 includes default text 852, 854, 856, 858, 860, 862, 864, 866, 868, 869 each associated with respective elements of field identification set 710. In some embodiments, default text is limited to text, while in other embodiments, default text can include text, graphics or a combination thereof. Custom text set 870 includes custom text 872, 874, 876, 878, 880, 882, 884, 886, 888, 889 each associated with respective elements of field identification set 710. In some embodiments, custom text is limited to text, while in other embodiments, custom text can include text, graphics or a combination thereof.

In operation, translation master 800 causes graphical interface 700 to display using text and/or graphics provided in translation master 800. Where fields associated with custom text set 870 are not defined (e.g., the fields remain <your translation here>), the default text is displayed on graphical interface 700. Additionally, where any of selection boxes 832, 834, 836, 838, 840, 842, 844, 846, 848 associated with inclusion set 830 are not selected (e.g., selection box 840), the associated field is not displayed.

Referring to FIG. 4b, graphical interface 801, based on graphical interface 700 updated with translation master 800, is illustrated. Consistent with the previous description, graphical interface 801 includes values from default text set 850 incorporated into the various fields of graphical interface 700. More specifically, referring to graphical interface 801, logo 710 is the default “NETDELIVERY” 852, date 720 is the default “May 25, 2001” 854, greeting 725 is the default “WELCOME” 856, request 730 is the default “ENTER YOUR ADDRESS” 858, entry field A 740 is the default “STREET NUMBER” 860, entry field B 750 is the default “APARTMENT NUMBER” 862, entry field C 760 is not used as selection box 844 is not selected, entry field D 770 is the default “CITY, STATE” 866, entry field E 780 is the default “COUNTRY” 868, and entry field F 790 is the default “ZIP CODE” 869.

Referring to FIG. 5a, a translation master 900, based on translation master 800 extended to include portions of custom text set 970 added in accordance with an embodiment of the present invention is described. Similar to translation master 800, translation master 900 includes field identification set 810, field inclusion set 830 and default text set 850. In contrast to translation master 800, translation master 900 includes a custom text set 970 that is partially populated. More particularly, elements 972, 989 associated with custom text set 970 do not include any custom text. Further, elements 972, 989 are associated with de-selected selection boxes 832, 849, respectively. Thus, elements 972, 989 are not displayed on a graphical interface associated with translation master 900. All other selection boxes 834, 836, 838, 840, 842, 844, 846, 848 are selected and therefore the associated custom text is displayed on the graphical interface.

Referring to FIG. 5b, graphical interface 901, based on graphical interface 700 updated with translation master 900, is illustrated. Consistent with the previous description, graphical interface 901 includes values from custom text set 970 incorporated into the various fields of graphical interface 700. More specifically, referring to graphical interface 901, logo 710 is not used as selection box 832 is not selected, date 720 is the custom “25 de Mayo 2001” 974, greeting 725 is the custom “BIENVENIDOS” 876, request 730 is the custom “ESCRIBA SU DIRECCION” 978, entry field A 740 is the custom “NUMERO DE LA CASA” 980, entry field B 750 is the custom “NUMERO DEL CUARTO” 982, entry field C 760 is the custom “ENTRE CALLES” 984, entry field D 770 is the custom “CIUDAD” 986, entry field E 780 is the custom “PAIS” 988, and entry field F 790 is not used as selection box 849 is not selected.

It should be recognized that any of the fields may be either included or excluded using the inclusion selection set 830. Additionally, it should be recognized that any combination of default and/or custom entries can be used depending upon information entered in custom text set 970. Thus, for example, where only one of custom text set 970 is populated, default text set 850 will be used to populate various included fields except for the field associated with the populated element of custom text select set 970.

Various embodiments of the present invention involve processes that can be integrated into a shops gather process to create application that supports multiple languages and/or users. For example, the present invention can support different branding and/or company logos using a single generic application. In some embodiments, the applications are web based applications. In particular embodiments, the web based applications are JAVA Server Pages. The present invention provides for supporting multiple languages and/or users without requiring specific applications tailored to the specific language and/or user. This reduces the amount of support required as only a single generic application must be maintained, with all tailoring done via a translation master.

In some embodiments, the present invention is used to take an English translation master for a first brand and a French translation master for a second brand and combine them with a set of JAVA Server Pages to create a set of JAVA Server Pages displayed in English and tailored to the first brand and create another set of JAVA Server Pages displayed in French and tailored to the second brand.

As can be appreciated from the preceding description, the present invention provides a number of advantages. For example, the present invention provides for significant reduction in development and maintenance time related to applications by reducing the number of applications that must be developed and maintained. In addition, the present invention provides systems and methods whereby only a single set of application logic must be developed and maintained. The application logic is then reused for different languages and brands by application of a translation master and/or a specific data set. This provides for increased stability as the need to change the application logic is drastically reduced. Further, The present invention allows for presentation logic to be provided in the generic application and eliminates the need to replicate presentation logic across different brands and language implementations.

Previously incorporated by reference, U.S. patent application Ser. No. ______, entitled SYSTEMS AND METHODS FOR IMPLEMENTING DATABASE INDEPENDENT APPLICATIONS (Attorney Docket No. 019555-005200US) discusses various configurations in relation to databases and/or other data defining layers that can be used in relation to the present invention. For example, various embodiments of the present invention can operate in relation to the system as provided in FIGS. 1 and 2 of the aforementioned application.

The invention has now been described in detail for purposes of clarity and understanding. However, it will be appreciated that certain changes and modifications may be practiced within the scope of the appended claims. For example, a process whereby an alternate database is implemented, encryption is performed and a data access layer is created in a single step can be performed in accordance with the present invention. Additionally, any type of application and or database can be manipulated and/or used in relation to the present invention to implement alternate databases and/or data access layers. Furthermore, a number of known encryption processes and/or devices can be used to perform the methods and implement systems in accordance with the present invention.

Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for implementing an application that is extensible to a plurality of specific application formats, the method comprising:
creating a generic application;
creating a translation master associated with the generic application; and
applying the translation master to the generic application, wherein a specific application is provided.

2. The method of claim 1, wherein the generic application is applicable to a group of countries and wherein the specific application is specific to a subset of the group of countries.

3. The method of claim 1, wherein the generic application comprises a data entry field and wherein the translation master provides a default designation for the data entry field.

4. The method of claim 3, wherein the applying the translation master to the generic application comprises displaying the default designation in association with the data entry field.

5. The method of claim 3, the method further comprising:
providing an alternative designation to the default designation in the translation master, wherein the applying the translation master to the generic application comprises displaying the alternative designation in association with the data entry field.

6. The method of claim 5, wherein the default designation is in a first language and the alternative designation is in a second language.

7. The method of claim 3, wherein the data entry field is a first data entry field and the default designation is a first default designation, and wherein the generic application further comprises a second data entry field and the translation master further comprises a second default designation associated with the second data entry field, the method further comprising:
providing an alternative designation to the first default designation in the translation master, wherein the applying the translation master to the generic application comprises displaying the alternative designation in association with the first data entry field and displaying the second default designation in association with the second data entry field.

8. The method of claim 1, wherein the translation master comprises an inclusion field associated with a generic field of the generic application.

9. The method of claim 8, the method further comprising:
selecting the inclusion field, wherein the generic field of the generic application is displayed.

10. The method of claim 9, wherein the translation master further comprises a default designation associated with the inclusion field, and wherein the default designation is displayed in association with the generic field of the generic application.

11. The method of claim 9, wherein the translation master further comprises a default designation and an alternative designation associated with the inclusion field, and wherein the alternative designation is displayed in association with the element of the generic application.

12. A system for implementing an application that is extensible to a plurality of specific application formats, the system comprising:
a computer readable medium comprising:
a generic application, wherein the generic application comprises a field;
a translation master, wherein the translation master comprises a default designation associated with the field; and
computer instructions, wherein the computer instructions are executable by a computer to:
apply the translation master to the generic application, wherein a specific application is provided.

13. The system of claim 12, wherein the field is a data entry field and wherein the default designation describes the data entry field.

14. The system of claim 13, wherein the computer instructions that apply the translation master to the generic application are executable to display the default designation in association with the data entry field.

15. The system of claim 13, wherein the translation master further comprises:
an alternative designation to the default designation, wherein the computer instructions that apply the translation master to the generic application are executable to display the alternative designation in association with the data entry field.

16. The system of claim 15, wherein the default designation is in a first language and the alternative designation is in a second language.

17. The system of claim 12, wherein the translation master further comprises an inclusion field associated with the field of the generic application.

18. The system of claim 17, wherein the computer instructions further comprise:
computer instructions executable by the computer to:
select the inclusion field, wherein the computer instructions that apply the translation master to the generic application are executable to display the default designation in association with the field only where the inclusion field is selected.

19. The system of claim 13, wherein the translation master further comprises an inclusion field associated with the data entry field and an alternative designation to the default designation, and wherein the computer instructions further comprise:
computer instructions executable by the computer to:
select the inclusion field, wherein the computer instructions that apply the translation master to the generic application are executable to display the alternative designation in association with the data field only where the inclusion field is selected.

20. A computer readable medium comprising elements for executing a generic application in a manner specific to a designated country, the computer readable medium comprising:
a generic application, wherein the generic application comprises a first field and a second field;
a translation master, wherein the translation master comprises a first default designation associated with the first field, a second default designation provided in a first language and associated with the second field, and an alternative designation provided in a second language and associated with the second field; and
computer instructions, wherein the computer instructions are executable by a computer to:
apply the translation master to the generic application, wherein a specific application is provided comprising a display of the first default associated with the first field and the alternative designation associated with the second field.

21. The computer readable medium of claim 20, the computer readable medium further comprising:
an inclusion field associated with the first field, wherein the computer instructions are further executable to:
select the inclusion field, wherein the computer instructions that apply the translation master to the generic application only display the first default designation where the inclusion field is selected.
